(19) United States
(12) Patent Application Publication
(10) Pub. No.: US 2024/0183294 A1
(43) Pub. Date: Jun. 6, 2024

(54) SOUND-ABSORBING SILENCER HAVING DIFFUSE REFLECTION STRUCTURE

(71) Applicants: Nam Do BAEK, Busan (KR); Geun Uk BAEK, Busan (KR)

(72) Inventors: Nam Do BAEK, Busan (KR); Geun Uk BAEK, Busan (KR)

(73) Assignee: Nam Do BAEK, Busan (KR)

(21) Appl. No.: 18/387,532

(22) Filed: Nov. 7, 2023

(30) Foreign Application Priority Data
Dec. 2, 2022 (KR) 10-2022-0166420

(51) Int. Cl. F01N 1/08

(52) U.S. Cl. CPC F01N 1/082; F01N 2210/06

(57) ABSTRACT

Disclosed is a sound-absorbing silencer having a diffuse reflection structure. The silencer includes a housing including an inlet and an outlet formed in respective ends thereof to allow noise to be introduced thereinto and discharged therefrom and a noise-attenuating unit disposed in the housing to attenuate noise through diffuse reflection and absorption of the noise. The noise-attenuating unit includes a first diffuse reflection pipe disposed in the housing while being spaced apart from the housing, at least one second diffuse reflection pipe accommodated in the first diffuse reflection pipe while being spaced apart from the first diffuse reflection pipe to form a noise-attenuating path therebetween so that noise is diffusely reflected and absorbed while flowing through the noise-attenuating path, and a sound-absorbing member disposed between the first diffuse reflection pipe and the housing and in the second diffuse reflection pipe to absorb noise diffusely reflected in the noise-attenuating path.

### BACKGROUND OF THE INVENTION

### Field of the Invention

The present invention relates to a sound-absorbing silencer having a diffuse reflection structure, and more particularly, to a sound-absorbing silencer having a diffuse reflection structure, which may attenuate noise by diffusely reflecting noise introduced thereinto in various directions.

### Description of the Related Art

In general, a silencer functions to attenuate noise propagating through the interior thereof without impeding free flow of fluid. A silencer is largely classified into a reactive silencer, an absorptive silencer, and a reactive-absorptive silencer according to an operational principle thereof.

For example, pneumatic devices (e.g., compressors, blowers, etc.), which are driven using pneumatic air, have been developed toward higher power and higher capacity, and accordingly, a larger amount of noise is generated therefrom.

In particular, when the pressure of discharged fluid is 10 bar or more, the amount of noise attenuated is extremely small, making it difficult to reduce noise.

Recently, environmental damage caused by noise has emerged as a major social problem. Therefore, systems for promotion of a silent environment have been prepared. For example, indication of a noise level of machinery has been made obligatory.

A conventional silencer may reduce noise to a certain extent. However, for example, when the pressure of fluid discharged from a high-output pressure tank is 10 bar or more, the conventional silencer has a limitation in attenuating noise. Therefore, it has become an urgent issue to develop a silencer capable of more effectively attenuating noise.

### RELATED ART DOCUMENT

### Patent Document

(Patent Document 0001) Korean Utility Model Registration No. 20-0343919
(Patent Document 0002) Korean Patent Registration No. 10-0398489

### SUMMARY OF THE INVENTION

The present invention has been made to solve the above problems, and it is an object of the present invention to provide a sound-absorbing silencer having a diffuse reflection structure, which may attenuate high-output noise introduced thereinto by causing the noise to collide with a plurality of peaks and valleys of diffuse reflection pipes so as to be diffusely reflected and causing the diffusely reflected noise to be absorbed by a sound-absorbing member.

In accordance with the present invention, the above and other objects can be accomplished by the provision of a sound-absorbing silencer having g a diffuse reflection structure, which includes a housing including an inlet and an outlet formed in respective ends thereof to allow noise to be introduced thereinto and discharged therefrom and a noise-attenuating unit disposed in the housing to attenuate noise introduced thereinto through diffuse reflection and absorption of the noise. The noise-attenuating unit includes a first diffuse reflection pipe disposed in the housing so as to be spaced apart from the housing, at least one second diffuse reflection pipe accommodated in the first diffuse reflection pipe so as to be spaced apart from the first diffuse reflection pipe to form a noise-attenuating path therebetween so that noise is diffusely reflected and absorbed while flowing through the noise-attenuating path, and a sound-absorbing member disposed between the first diffuse reflection pipe and the housing and in the second diffuse reflection pipe to absorb noise diffusely reflected in the noise-attenuating path.

The first diffuse reflection pipe and the second diffuse reflection pipe may include a plurality of sounding-absorbing holes formed through the surfaces thereof so that the noise flowing through the noise-attenuating path passes through the plurality of sound-absorbing holes and is absorbed by the sound-absorbing member.

The first diffuse reflection pipe and the second diffuse reflection pipe including the sound-absorbing holes may be formed in the shape of a bellows including peaks and valleys in order to diffusely reflect noise and to cause the diffusely reflected noise to pass through the plurality of sound-absorbing holes.

The sound-absorbing member may be made of a material selected from among textile, felt, and glass fiber.

The first diffuse reflection pipe may be formed to have two opposite open ends, and the second diffuse reflection pipe may be formed to be sealed.

### BRIEF DESCRIPTION OF THE DRAWINGS

The above and other objects, features, and other advantages of the present invention will be more clearly understood from the following detailed description taken in conjunction with the accompanying drawings, in which:

FIG. 1 is a perspective view of a sound-absorbing silencer having a diffuse reflection structure according to the present invention with a housing and a first diffuse reflection pipe partially cut away;

FIG. 2 is a perspective view of the sound-absorbing silencer having a diffuse reflection structure shown in FIG. 1 with a second diffuse reflection pipe partially cut away;

FIG. 3 is an enlarged perspective view showing a main part of the pipe; and

FIG. 4 is a reference diagram showing a noise attenuation process in which noise introduced into the silencer is diffusely reflected by the first and second diffuse reflection pipes and, at the same time, is absorbed by a sound-absorbing member.

### DETAILED DESCRIPTION OF THE INVENTION

Hereinafter, exemplary embodiments of the present invention will be described below in detail with reference to the accompanying drawings. The present invention may, however, be embodied in many different forms, and should not be construed as being limited to the embodiments set forth herein. Rather, these embodiments are provided so that this disclosure will be thorough and complete, and will fully convey the scope of the invention to those skilled in the art. In the drawings, the sizes or shapes of components may be exaggerated or schematically illustrated for clarity and convenience of description.

It will be understood that, although the terms “first”, “second”, etc. may be used herein to describe various elements, these elements should not be limited by these terms. These terms are only used to distinguish one element from another.

The terminology used herein is for the purpose of describing particular embodiments only and is not intended to be limiting of exemplary embodiments of the invention. As used herein, the singular forms are intended to include the plural forms as well, unless the context clearly indicates otherwise. It will be further understood that the term “include” or “have”, when used herein, specifies the presence of stated features, integers, steps, operations, elements, components, or combinations thereof, but do not preclude the presence or addition of one or more other features, integers, steps, operations, elements, components, or combinations thereof.

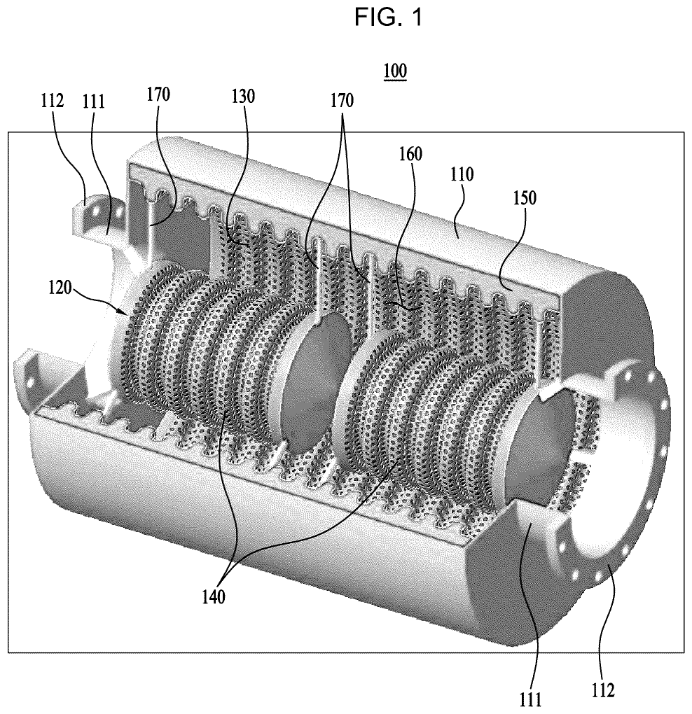

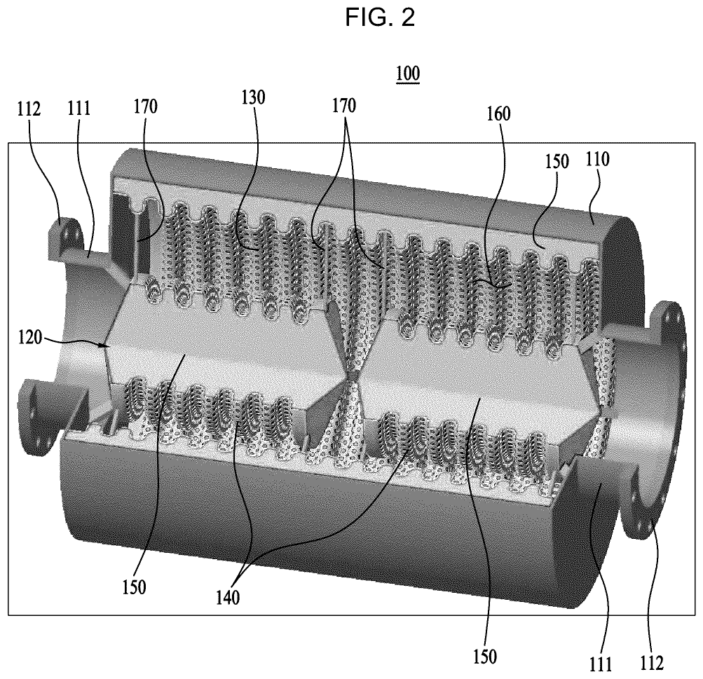

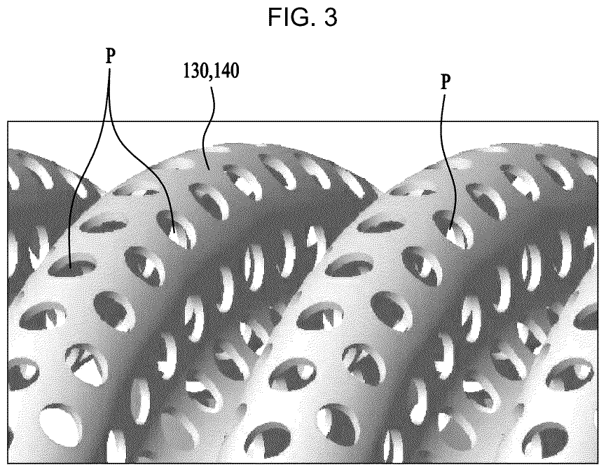

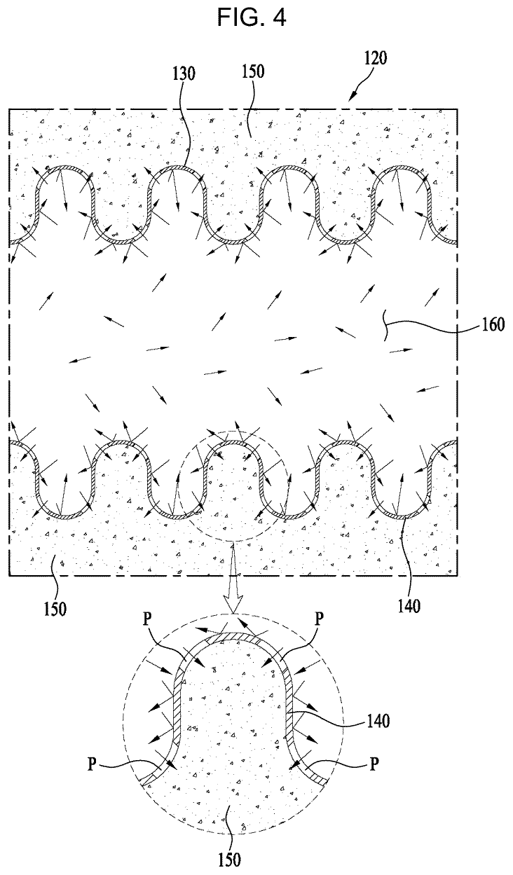

FIG. 1 is a perspective view of a sound-absorbing silencer having a diffuse reflection structure according to the present invention with a housing and a first diffuse reflection pipe partially cut away. FIG. 2 is a perspective view of the sound-absorbing silencer having a diffuse reflection structure shown in FIG. 1 with a second diffuse reflection pipe partially cut away. FIG. 3 is an enlarged perspective view showing a main part of the pipe. FIG. 4 is a reference diagram showing a noise attenuation process in which noise introduced into the silencer is diffusely reflected by the first and second diffuse reflection pipes and, at the same time, is absorbed by a sound-absorbing member.

As shown in FIGS. 1 to 4, a sound-absorbing silencer 100 having a diffuse reflection structure according to the present invention includes a housing 110 having an inlet and an outlet formed in respective ends thereof to allow noise to be introduced thereinto and discharged therefrom and a noise-attenuating unit 120 disposed in the housing 110 to attenuate noise introduced thereinto through diffuse reflection and absorption of the noise. The noise-attenuating unit 120 includes a first diffuse reflection pipe 130 disposed in the housing 110 so as to be spaced apart from the housing 110, at least one second diffuse reflection pipe 140 accommodated in the first diffuse reflection pipe 130 so as to be spaced apart from the first diffuse reflection pipe 130 to form a noise-attenuating path 160 therebetween so that noise is diffusely reflected and absorbed while flowing through the noise-attenuating path 160, and a sound-absorbing member 150 disposed between the first diffuse reflection pipe 130 and the housing 110 and in the second diffuse reflection pipe 140 to absorb noise diffusely reflected in the noise-attenuating path 160.

The sound-absorbing silencer 100 having a diffuse reflection structure according to the present invention is characterized by diffusely reflecting high-output noise a great number of times and absorbing the diffusely reflected noise using the sound-absorbing member 150.

The sound-absorbing silencer 100 having a diffuse reflection structure according to the present invention is connected to a pneumatic device or disposed between pipes through which noise flows in order to attenuate noise.

Hereinafter, the sound-absorbing silencer 100 having a diffuse reflection structure according to the present invention will be described in more detail.

The sound-absorbing silencer 100 having a diffuse reflection structure includes the housing 110 and the noise-attenuating unit 120.

The housing 110 functions to reduce the level of noise introduced thereinto. As shown in FIGS. 1 and 2, the housing 110 has an overall cylindrical shape so that the noise-attenuating unit 120, which will be described later, is disposed therein.

The housing 110 includes an inlet 111 and an outlet 111 formed in respective ends thereof in a longitudinal direction thereof so as to be open to allow noise to be introduced into the housing 110 and to discharge attenuated noise out of the housing 110. The housing 110 further includes flanges 112 formed at distal ends of the inlet 111 and the outlet 111 so as to be connected to other pipes.

The noise-attenuating unit 120 functions to reduce the level of noise by diffusely reflecting noise introduced into the housing 110 a great number of times and absorbing the diffusely reflected noise. The noise-attenuating unit 120 is disposed in the housing 110.

As shown in FIGS. 1 to 4, the noise-attenuating unit 120 includes the first diffuse reflection pipe 130, the second diffuse reflection pipe 140, and the sound-absorbing member 150.

The first diffuse reflection pipe 130 is disposed in the housing 110, and is formed in the shape of a cylinder having two opposite open ends to allow noise introduced thereinto to flow therethrough.

In this case, it is preferable for the first diffuse reflection pipe 130 to have a smaller diameter than the housing 110 so as to be disposed in the housing 110 in a state of being spaced apart from the housing 110.

The reason for this is to define a predetermined space so that the sounding-absorbing member 150, which will be described later, is disposed between the first diffuse reflection pipe 130 and the housing 110.

The second diffuse reflection pipe 140 is formed in the shape of a cylinder having a sealed inner space defined therein and a predetermined length. In this embodiment, two second diffuse reflection pipes 140 are accommodated in the first diffuse reflection pipe 130 so as to be arranged in a longitudinal direction thereof, and are supported by a plurality of fixing bars 170 connected to the first diffuse reflection pipe 130.

In this case, it is preferable for each of the second diffuse reflection pipes 140 to have a smaller diameter than the first diffuse reflection pipe 130 so as to be disposed in the first diffuse reflection pipe 130 in a state of being spaced apart from the first diffuse reflection pipe 130.

The reason for this is to form the noise-attenuating path 160, which is a space defined between the first diffuse reflection pipe 130 and the second diffuse reflection pipes 140 to allow noise introduced thereinto to flow therethrough. The level of noise flowing through the noise-attenuating path 160 is reduced.

In addition, in order not only to diffusely reflect noise flowing through the noise-attenuating path 160 but also to absorb the noise, the first diffuse reflection pipe 130 and the second diffuse reflection pipes 140 include a plurality of sounding-absorbing holes P formed through the surfaces thereof so that the noise flowing through the noise-attenuating path 160 passes through the sound-absorbing holes P and is absorbed by the sound-absorbing member 150, which will be described later.

The sound-absorbing holes P may be formed in one of a circular shape, an elliptical and a polygonal shape. In this embodiment, the sound-absorbing holes P are illustrated as being formed in a circular shape.

Further, as shown in FIG. 3, it is preferable for the first diffuse reflection pipe 130 and the second diffuse reflection pipes 140 including the sound-absorbing holes P to be formed in the shape of a bellows including peaks and valleys having a predetermined height and depth. Accordingly, the noise flowing through the noise-attenuating path 160 is diffusely reflected in various directions by colliding with the peaks and the valleys of the first and second diffuse reflection pipes 130 and 140, and the diffusely reflected noise enters the first and second diffuse reflection pipes 130 and 140 through the plurality of sound-absorbing holes P.

In this case, the sizes of the peaks and the valleys of the first and second diffuse reflection pipes 130 and 140 may vary depending on the overall size or mounting place of the sound-absorbing silencer 100 having a diffuse reflection structure according to the present invention.

As such, when the first diffuse reflection pipe 130 and the second diffuse reflection pipes 140 are formed in the shape of a bellows including peaks and valleys, the noise flowing through the noise-attenuating path 160 collides with the peaks and the valleys of the first and second diffuse reflection pipes 130 and 140 a great number of times, as shown in FIG. 4. In this process, the noise is diffusely reflected in various directions, and thus the level thereof is reduced. Further, the diffusely reflected noise is absorbed by the sound-absorbing member 150, which will be described later, through the plurality of sound-absorbing holes P, and thus the noise is attenuated.

The sound-absorbing member 150 functions to absorb the noise diffusely reflected by the peaks and the valleys of the first and second diffuse reflection pipes 130 and 140 while the noise flows through the noise-attenuating path 160. The sound-absorbing member 150 is interposed between the first diffuse reflection pipe 130 and the housing 110, and is disposed in the second diffuse reflection pipes 140.

The sound-absorbing member 150 is made of a material capable of effectively absorbing noise and suppressing discharge of the noise absorbed therein. For example, the sound-absorbing member 150 may be made of a material having a plurality of fine pores, such as textile, felt, or glass fiber.

Since the sound-absorbing member 150 is widely used in various industrial fields, a detailed description of the structure thereof will be omitted.

The noise-attenuating unit 120 structured as described above induces diffuse reflection of noise flowing through the noise-attenuating path 160 using the peaks and the valleys of the first and second diffuse reflection pipes 130 and 140, thereby reducing the noise level, and causes the diffusely reflected noise to be absorbed by the sound-absorbing member 150 through the plurality of sound-absorbing holes P formed in the peaks and the valleys of the first and second diffuse reflection pipes 130 and 140, thereby attenuating the noise.

Although this embodiment has been described as including two second diffuse reflection pipes 140, the embodiment is not limited to any specific number of second diffuse reflection pipes 140. A single second diffuse reflection pipe 140 may be mounted.

Hereinafter, the process of attenuating noise using the sound-absorbing silencer 100 having a diffuse reflection structure according to the present invention will be described with reference to the accompanying drawings.

First, the sound-absorbing silencer 100 having a diffuse reflection structure is connected to a pneumatic device (not shown) or a pipe (not shown) through which noise flows through the inlet 111 and the outlet 111 formed in respective ends thereof.

In this state, noise (fluid) is introduced into the noise-attenuating path 160 between the first diffuse reflection pipe 130 and the second diffuse reflection pipes 140, and flows through the noise-attenuating path 160.

As shown in FIG. 4, while the noise flows through the noise-attenuating path 160, the noise continuously collides with the plurality of peaks and valleys of the first diffuse reflection pipe 130 and the second diffuse reflection pipes 140. In this process, the noise is diffusely reflected in various directions, as indicated by arrows in FIG. 4.

The level of the diffusely reflected noise is gradually reduced by continuous collision of the noise with the peaks and the valleys of the first and second diffuse reflection pipes 130 and 140, and at the same time, the noise is absorbed by the sounding-absorbing member 150 through the plurality of sound-absorbing holes P formed in the first and second diffuse reflection pipes 130 and 140.

In addition, a portion of the noise that is not absorbed by the sound-absorbing member 150 continuously collides with the peaks and the valleys of the first and second diffuse reflection pipes 130 and 140 while flowing through the noise-attenuating path 160, whereby the noise attenuated to a minimum level is discharged to the outside of the housing 110 through the outlet 111.

As is apparent from the above description, the sound-absorbing silencer having a diffuse reflection structure according to the present invention exhibits effect of reliably attenuating high-output noise introduced thereinto by causing the high-output noise to flow through the noise-attenuating path between the first diffuse reflection pipe and the second diffuse reflection pipes, diffusely reflecting the high-output noise a great number of times using the peaks and the valleys of the first and second diffuse reflection pipes, and causing the diffusely reflected noise to be absorbed by the sound-absorbing member provided in the diffuse reflection pipes.

Although specific embodiments of the present invention have been disclosed for illustrative purposes, those skilled in the art will appreciate that various modifications, additions, and substitutions are possible, without departing from the scope and spirit of the invention as disclosed in the accompanying claims.

What is claimed is:

1. A sound-absorbing silencer having a diffuse reflection structure, the silencer comprising:
a housing comprising an inlet and an outlet formed in respective ends thereof to allow noise to be introduced thereinto and discharged therefrom; and
a noise-attenuating unit disposed in the housing to attenuate noise introduced thereinto through diffuse reflection and absorption of noise,
wherein the noise-attenuating unit comprises:
a first diffuse reflection pipe disposed in the housing so as to be spaced apart from the housing;
at least one second diffuse reflection pipe accommodated in the first diffuse reflection pipe so as to be spaced apart from the first diffuse reflection pipe to form a noise-attenuating path therebetween so that noise is diffusely reflected and absorbed while flowing through the noise-attenuating path; and
a sound-absorbing member disposed between the first diffuse reflection pipe and the housing and in the at least one second diffuse reflection pipe to absorb noise diffusely reflected in the noise-attenuating path.

2. The silencer according to claim 1, wherein the first diffuse reflection pipe and the at least one second diffuse reflection pipe comprise a plurality of sounding-absorbing holes formed through surfaces thereof so that noise flowing through the noise-attenuating path passes through the plurality of sound-absorbing holes and is absorbed by the sound-absorbing member.

3. The silencer according to claim 2, wherein the first diffuse reflection pipe and the at least one second diffuse reflection pipe comprising the sound-absorbing holes are formed in a shape of a bellows comprising peaks and valleys in order to diffusely reflect noise and to cause the diffusely reflected noise to pass through the plurality of sound-absorbing holes.

4. The silencer according to claim 1, wherein the sound-absorbing member is made of a material selected from among textile, felt, and glass fiber.

5. The silencer according to claim 1, wherein the first diffuse reflection pipe is formed to have two opposite open ends, and the at least one second diffuse reflection pipe is formed to be sealed.
